(19) United States
(12) Patent Application Publication
(10) Pub. No.: US 2007/0073761 A1
(43) Pub. Date: Mar. 29, 2007

(54) Continual generation of index advice

(75) Inventors: Mark J. Anderson, Oronoco, MN (US); Robert J. Bestgen, Rochester, MN (US); James M. Flanagan, Rochester, MN (US); Scott Forstie, Rochester, MN (US); Thomas J. Schreiber, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/239,617

(22) Filed: Sep. 29, 2005

(51) Int. Cl. G06F 7/00

(52) U.S. Cl. 707/102

(57) ABSTRACT

Continual generation of index advice that includes generating an index advice for an index of a table in a computer database and recording values of statistical attributes of the index advice accumulated across repeated generations of the index advice. The generating and recording typically are carried out continually without user intervention. Embodiments include recording values of attributes of the index advice that specify an index. Typical embodiments also include, continually and without user intervention, recording values of attributes of the index advice that characterize usefulness of an index and recording values of attributes of the index advice that characterize cost of creating an index.

### BACKGROUND OF THE INVENTION

1. Field of the Invention

The field of the invention is data processing, or, more specifically, methods, apparatus, and products for continual generation of index advice.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a grouping of related structures called ‘tables,’ which in turn are organized in rows of individual data elements. The rows are often referred to as ‘records,’ and the individual data elements are referred to as ‘fields’ or ‘columns.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:
select * from stores, transactions
where stores.location=“Minnesota”
and stores.storeID=transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

Enterprise application environments support huge database-oriented business applications that present a substantial performance demands to a DBMS. Such large applications include, for example, enterprise resource planning (‘ERP’) applications, customer relations management (‘CRM’) applications, and supply chain management (‘SCM’) applications. These giant application environments all have one thing in common, they need to operate efficiently or a business will suffer financially. Tuning these large, complex applications can be a daunting task. The options users have are limited. A useful way to leverage database performance is to create indexes—because performance-enhancing modifications to applications often are practically impossible to make or, if possible, cost prohibitive.

An index is a set of pointers to rows of a database table, that is, a list of locations of rows in a table sorted by the contents of one or more specified columns. Each index is based on the values of data in one or more table columns. An index is an object that is separate from the data in the table indexed by the index. When a user requests a DBMS to create an index, the DBMS builds this structure and maintains it automatically.

Indexes may be used to speed up access to a table. Indexes also can serve a logical data design purpose. A unique index, for example, allows no entry of duplicate values in columns of a table, thereby guaranteeing that no two rows of a table are exactly the same. Indexes can also be created to specify ascending or descending order of the values in a column.

An ‘index key’ is the column or columns on which an index is defined. The structure of the key of an index affects the usefulness of the index. The order of the columns in the key has no effect on index creation, but the order can affect how the index is used.

A DBMS typically includes software tools or utility programs for database performance analysis. Such tools or utilities often include a database monitor program or index advisor capable of recommending or ‘advising’ indexes as a means of helping a database administrator tune a database for performance. The advice is given back to the user in different forms. On IBM's DB2 UDB for iSeries, for example, the information can be seen by collecting and interrogating Database Monitor output with the STRDBMON command. The industry approach requires advanced knowledge of the specific platform and database. This makes tuning the database an action limited to an expert and even then, can be a tedious, time consuming task.

### SUMMARY OF THE INVENTION

Methods, apparatus, and computer program products are disclosed for continual generation of index advice that include generating an index advice for an index of a table in a computer database and recording values of statistical attributes of the index advice accumulated across repeated generations of the index advice. The generating and recording typically are carried out continually without user intervention. Embodiments include recording values of attributes of the index advice that specify an index. Typical embodiments also include, continually and without user intervention, recording values of attributes of the index advice that characterize usefulness of an index and recording values of attributes of the index advice that characterize cost of creating an index.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for continual generation of index advice according to embodiments of the present invention.

FIG. 2 sets forth a block diagram of automated computing machinery comprising an exemplary computer useful in continual generation of index advice according to embodiments of the present invention.

FIG. 3 sets forth a flow chart illustrating an exemplary method for continual generation of index advice according to embodiments of the present invention.

FIG. 4 sets forth an exemplary GUI display of an index advice record tool useful for administration of continual generation of index advice according to embodiments of the present invention.

### DETAILED DESCRIPTION OF EXEMPLARY EMBODIMENTS

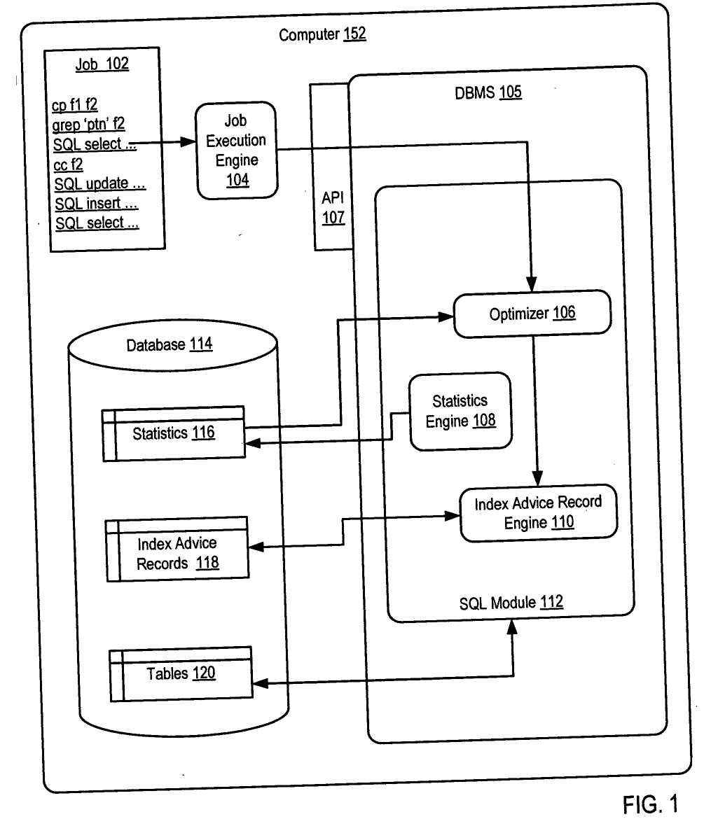

Exemplary methods, apparatus, and products for continual generation of index advice according to embodiments of the present invention are described with reference to the accompanying drawings, beginning with FIG. 1. FIG. 1 sets forth a block diagram of an exemplary system for continual generation of index advice according to embodiments of the present invention. The exemplary system of FIG. 1 includes an SQL module (112). The SQL module is implemented as computer program instructions that execute an SQL query against tables (120) of database (114). In the example of FIG. 1, SQL module (112) receives SQL queries for execution from job execution engine (104). Job execution engine (104) is a software module that executes jobs, such as job (102), by passing commands from the jobs to software applications appropriate to the command. Jobs may mingle SQL queries with other commands to perform various data processing tasks. Job (102), for example, includes several commands for execution as part of job (102), including:
cp f1 f2: an operating system command to copy one file to another file,
grep ‘ptn’ f2: a general regular expression command of the operating system to find occurrences of ‘ptn’ in file f2,
cc f2: a command to compile file f2 as a C program, and
several SQL commands, each of which passes as a parameter to an executable command named ‘SQL’ call parameters identifying an SQL query.

In this example, job execution engine (104) will pass the operating system commands from job (102) to an operating system for execution and pass the SQL queries from job (102) to SQL module (112) for execution. Job execution engine (104) passes the SQL queries to SQL module (112) through application programming interface (‘API’) (107) of database management system (‘DBMS’) (105). DBMS (105) provides database management functions for database (114). DBMS (1064 exposes API (107) to enable applications, including, for example, job execution engine (104) to access functions of the DBMS, including, for example, SQL module (112). The ‘SQL’ command illustrated in job (102) is a function made available through API (107).

The system of FIG. 1 includes optimizer (106) as part of the SQL module. Optimizer (106) optimizes the execution of SQL queries against DBMS (105). DBMS (105) is a DBMS that administers access to the contents of database (114). Optimizer (106) is implemented as computer program instructions that optimize execution of a SQL query in dependence upon database management statistics (116). Database statistics may reveal, for example, that there are only two zip code values in a user account table—so that it is an optimization, that is, more efficient, to scan the user account table rather than using index access. Alternatively, database statistics may reveal that there are many user account records, only a few of which have zip code values in a range of interest—so that for a particular SQL query it is an optimization to access the user account table by an index.

Database statistics (116) are typically implemented as metadata of a table, such as, for example, metadata of tables of database (114). Database statistics may include, for example:
histogram statistics: a histogram range and a count of values in the range,
frequency statistics: a frequency of occurrence of a value in a column, and
cardinality statistics: a count of the number of different values in a column.

These three database statistics are presented for explanation only, not for limitation. The use of any database statistics as will occur to those of skill in the art is well within the scope of the present invention.

Optimizer (106) uses database statistics (116) from database (114) for optimizing SQL queries against database (114). Optimizer (106) may notify statistics engine (108) when the optimizer attempts to use databases statistics for a column of a table, for example, and finds the database statistics missing or stale. Statistics engine (108) generates the missing or stale statistics.

Optimizer (106) is improved according to embodiments of the present invention to support continual generation of index advice by generating an index advice for an index of a table in a computer database and providing the index advice to index advice record engine (110). Index advice record engine (110) is a module of computer program instructions in the SQL module (112) improved according to embodiments of the present invention to record values of statistical attributes and other attributes of an index advice provided to it by the optimizer (106). In this example, index advice record engine (110) records values of attributes of index advice across repeated generations of an index advice in index advice records (118). Optimizer (106) and index advice record engine (110) work together to implement continual generation of index advice according to embodiments of the present invention so that generating index advice and recording attributes of index advice across repeated generations of the index advice is carried out continually without user intervention.

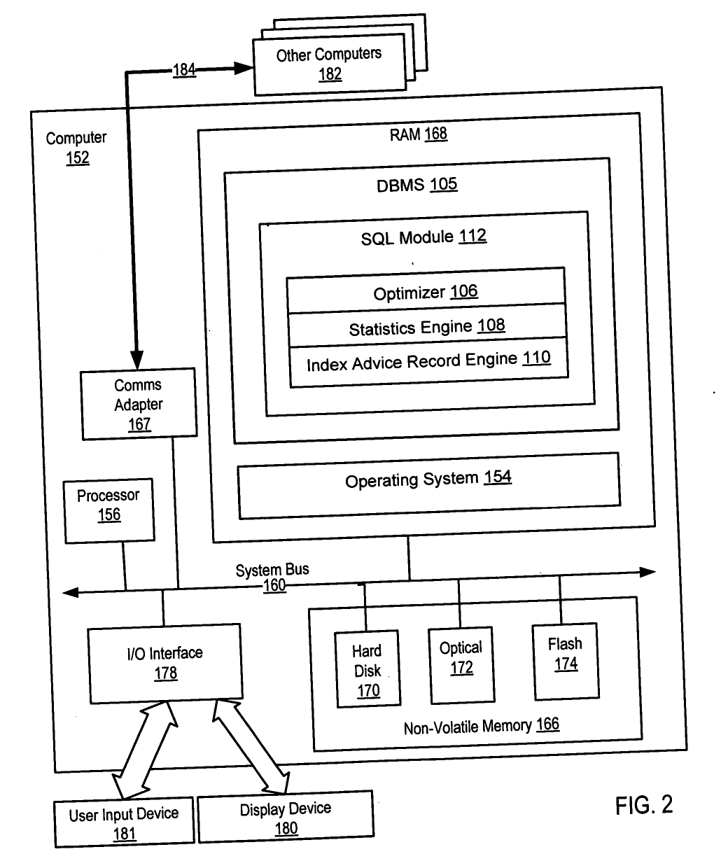

Continual generation of index advice in accordance with the present invention is generally implemented with computers, that is, with automated computing machinery. For further explanation, therefore, FIG. 2 sets forth a block diagram of automated computing machinery comprising an exemplary computer (152) useful in continual generation of index advice according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is DBMS (105), computer program instructions for database management. The DBMS (105) of FIG. 2 includes an SQL module (112), which in turn includes an optimizer (106), a statistics engine (108), and an index advice record engine (110), each of which implement computer program instructions stored in RAM (168) that operate computer (152) as described above to provide continual generation of index advice and recording of attributes of index advice across repeated generations of index advice with no need for user intervention.

Also stored in RAM (168) is an operating system (154). Operating systems useful in computers according to embodiments of the present invention include UNIX™, Linux™, MicrosoftXP™, AIX™, IBM's i5/OS™, and others as will occur to those of skill in the art. Operating system (154) and DBMS (105) in the example of FIG. 2 are shown in RAM (168), but many components of such software may be stored in non-volatile memory (166) also.

Computer (152) of FIG. 2 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing connections for data communications (184) to other computers (182). Such connections may include serial connections such as RS-232 connections, connections through external buses such as USB connections, connections through data communications networks such as TCP/IP connections, and others as will occur to those of skill in the art. Communications adapters implement the hardware level of connections for data communications through which one computer sends data communications another computer, directly or through a network. Examples of communications adapters useful for mirroring database statistics according to embodiments of the present invention include modems for wired dial-up connections, Ethernet (IEEE 802.3) adapters for wired network connections, and 802.11b adapters for wireless network connections.

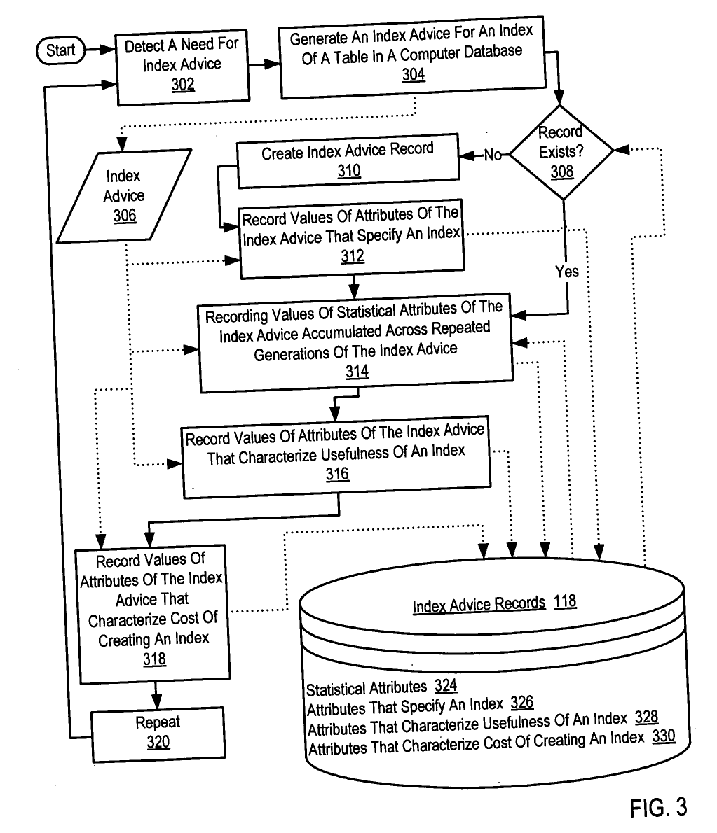

For further explanation, FIG. 3 sets forth a flow chart illustrating an exemplary method for continual generation of index advice according to embodiments of the present invention. The steps of the method repeat at step (320), so that the steps of the method run continually in a loop with no need for user intervention. The operation of the method of FIG. 3, implemented in computer software running on computer hardware, is continual—but not continuous.

The method of FIG. 3 begins by detecting (302) a need for index advice. The detecting step characterizes the operation of the method as continual but not continuous. The term ‘continual’ as used in this specification means ‘occurring repeatedly. The term ‘continuous’ as used in this specification means ‘going on without interruption.’ The detecting step pauses the operation of the method while an SQL module processes queries, for example, until in processing a query the SQL module detects a need for an index advice. Pausing operation of the loop until a need for an index advice is detected means that the operation of the steps of the method of FIG. 3, although configured in a loop, do not operate continuously. The steps of the method do operate continually, however, occurring repeatedly in their loop.

Detecting (302) a need for an index advice may be implemented by detecting by database statistics that an answer set of a query for which there is no matching index is much smaller than the table against which the query is asserted—so that using an index with the query can significantly improve performance of the query. Detecting a need for an index advice may be implemented by heuristics, inferring selectivity of a query from the structure of the query itself. A query on one non-unique field, for example, is likely to select many records. A query with several selection fields is likely to select fewer records. A query on a unique field is likely to select even fewer records. Detecting a need for an index advice may be implemented by determining that a query indicates a need to order a response, but no index matches the requested ordering, such as, for example, when a query contains an ORDER BY clause or a GROUP BY clause but there is no matching index. Other ways of detecting a need for an index advice may occur to those of skill in the art, and all such ways are well within the scope of the present invention.

The method of FIG. 3 also includes generating (304) an index advice for an index of a table in a computer database. Generating an index advice may be carried out by creating a data structure containing at least a sufficient number of attributes or fields to specify an index recommended by the index advice. Attributes that specify an index may be considered fields required to provide a unique key to the index advice in a table of index advice records. Attributes that specify an index may include the name of the table for which the index advice is generated, one or more names of columns of the table for the index, and an index type. Example of index types include binary radix indexes and encoded vector indexes. A binary radix index provides a specific order to the rows of a table while an encoded vector index does not. Both of these index types can be used to improve database performance.

Attributes of the index advice that specify an index optionally also may include, depending on the characteristics of the underlying DBMS, the location of the table to be indexed. The location of the table to be indexed may be implemented as a schema name or a library, folder, or subdirectory where the table is stored. The use of a table location to specify an index depends on the characteristics of the underlying DBMS because a particular DBMS may track table locations by table name, for example, with no need for separate specification of a table location.

Attributes of the index advice that specify an index optionally also may include, depending on the characteristics of the underlying DBMS, one or more names of leading order-independent column keys of the table for the index. Leading order-independent column keys are key fields for an index that are useful while analyzing the index advisor information by providing more combinations for indexes to match the queries being executed. By limiting the number of indexes created, the maximum performance benefit may be achieved with the lowest index maintenance cost.

Attributes of the index advice that specify an index optionally also may include, depending on the characteristics of the underlying DBMS, a name of a national language sort sequence table—if one is in use when the index advice is generated, and the location of the sort sequence table if there is one. A sort sequence defines how characters in a character set relate to each other when they are compared and ordered. Different sort sequences are useful for those who want their data ordered for a specific language. For example, lists can be ordered as they are normally seen for a specific language. A sort sequence can also be used to treat certain characters as equivalent, for instance, a and A. It is important to remember that the data itself is not altered by the sort sequence. A weighted representation of the data is used for the comparison. Since a sort sequence table affects the query which generated the index advice, it is useful to understand when a sort sequence table has been used, to maximize the use of any new indexes.

The method of FIG. 3 also includes recording (312) values of attributes (326) of the index advice (306) that specify an index. More particularly, the method of FIG. 3 includes recording (312) only once the values of attributes (326) of the index advice that specify an index. Values for attributes of the index advice may be recorded thousands of times because an index advice may be generated thousands of times. There is no need to record the unique key field values for the index advice every time the index advice is generated. Before recording (312) values of attributes (326) of the index advice that specify an index, therefore, the method of FIG. 3 determines (308) whether an index advice record (118) for the index advice exists. Determining whether an index advice record for the index advice exists can be carried out by querying the index advice records (118) with a unique key made up of values of attributes of an index advice (306) that specify the index advice. If an index advice record for the index advice does not yet exist, then the index advice just been generated for the first time, and the method of FIG. 3 proceeds to create (310) an index advice record in the index advice record table (118) and record (312) the values of attributes (326) of the index advice (306) that specify an index. If an index advice record for the index advice already exists, then the index advice has already been generated at least once, the values of attributes that specify an index have already been recorded, and the method of FIG. 3 skips the steps of creating (310) an index advice record and recording (312) the values of attributes (326) of the index advice (306) that specify an index.

The method of FIG. 3 also includes recording (314) values of statistical attributes (324) of the index advice accumulated across repeated generations of the index advice. Recording (314) values of statistical attributes (324) of the index advice accumulated across repeated generations of the index advice is accomplished in this example by recording (314) values of statistical attributes (324) of an index advice on each iteration of the processing loop of the method of FIG. 3. The values so recorded are ‘statistical’ in the sense of numerical summary measures of usefulness of an index based on data accumulated across repeated generations of an index advice.

In the method of FIG. 3, statistical attributes (324) of an index advice may include a cumulative count of the number of times that the index advice has been generated for the index. Such statistical attributes of an index advice also may include a largest estimate of the time required to execute a query for which the index advice was generated. Such a largest estimate of the time required to execute a query for which the index advice was generated may be recorded by estimating the time required to execute a query for which the index advice was generated every time the particular index advice is generated, comparing the estimate to an estimate recorded for a previous generation of the same index advice, and storing the larger of the two as the current largest estimate of the time required to execute a query for which the index advice was generated.

In the method of FIG. 3, statistical attributes (324) of the index advice may include a running average of estimates of the time required to execute a query for which the index advice was generated. Such a running average may be calculated according to:
R=((P×C)+E)/C+1,
where R is the current value of the running average, P is a previously calculated and stored value of the running average, C is a cumulative count of the number of times that the index advice has been generated for the index—recorded previously when P was calculated and stored, and E is a current estimate of the time required to execute a query for which the index advice was generated.

The method of FIG. 3 also includes recording (316) values of attributes (328) of the index advice that characterize usefulness of an index. In the method of FIG. 3, attributes (328) of the index advice that characterize usefulness of an index may include a timestamp representing the time when an index advice for an index was last generated.

In the method of FIG. 3, attributes (328) of the index advice that characterize usefulness of an index also may include a reason why an index advice for an index was last generated. Reason why an index advice for an index was last generated may include:
TABLE SCAN: No index on fields matching the fields in a WHERE clause of a query. The optimizer is forced to find records by scanning through the records of a table to select records satisfying the query.
ORDERING/GROUPING: No index on fields matching the fields in a ORDER BY clause or a GROUP BY clause of a query. Whereas a properly indexed search would have brought back records in a sequence that would satisfy required ordering or grouping, the optimizer now is forced to conduct an additional sort of query results to satisfy ordering or grouping.
TABLE SCANAND ORDERING/GROUPING: Combination of the two above. One index could be built to satisfy both requirements. For example:
   SELECT*FROM TABLE1 WHERE COLUMN1=‘ABC’ ORDER BY COLUMN1, COLUMN2.
In this example, an index built with a key definition of (COLUMN1, COLUMN2) could satisfy both the record selection and ordering. Without a fitting index, the optimizer must both scan the table to retrieve records satisfying the query and also sort the retrieved records to meet the ordering requirement of the query.

In the method of FIG. 3, attributes (328) of the index advice that characterize usefulness of an index also may include the number of rows in the table when an index advice for an index of the table was last generated. Despite the fact that an index for the table is advised, even if it is advised many times, a database administrator may judge it not worth the cost of creating an index if the number of records in the table is always small. If the number of records in the table is large, it may be worthwhile to index the table even if index advice for the table is rarely generated.

The method of FIG. 3 also includes recording (318) values of attributes (330) of the index advice that characterize cost of creating an index. In the method of FIG. 3, attributes (330) of the index advice that characterize cost of creating an index may include an estimate of the time required to create the index. An optimizer may be configured with an average access time for retrieval of a record of a table. The optimizer may then use database statistics to estimate the number of records required to supply all the values of key columns for the index. The optimizer then may use the average access time and the number of required records to estimate the time required to create the index. The estimate is carried out in terms of real world units, that is, seconds.

In the method of FIG. 3, attributes (330) of the index advice that characterize cost of creating the specified index may include a page size for the index. Page size indicates a working set size for the index. Indexes with larger logical page sizes are typically more efficient when scanned during query processing. Small page sizes are more efficient for index probes and individual lookup keys. An index probe is a query or a portion of query processing that returns records located with an index. An individual key lookup is query processing that returns a single record located with an index.

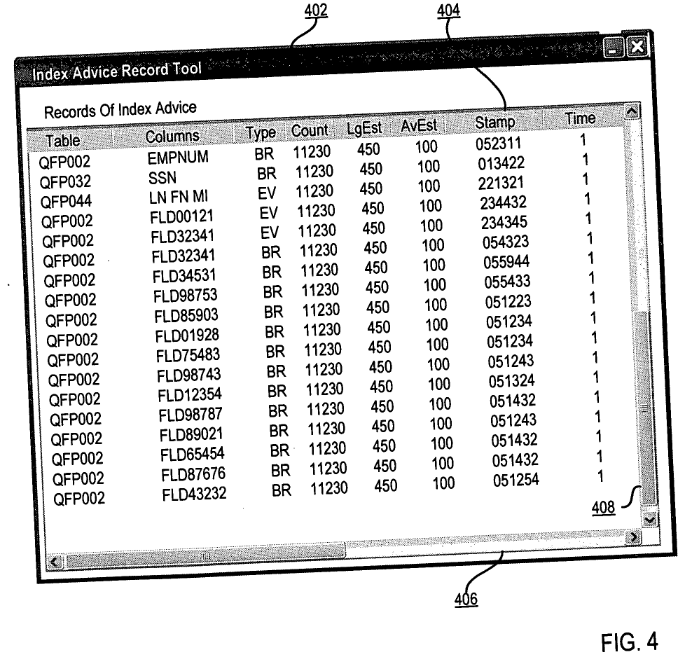

For further explanation, FIG. 4 sets forth an exemplary GUI display (402) of an index advice record tool useful for administration of continual generation of index advice according to embodiments of the present invention. The exemplary display of FIG. 4 includes a text box (404) in which are rows of a table in which are recorded attributes of index advice. Each of the eighteen rows in text box (404) represents an index advice has been repeatedly generated and for which values of attributes have been recorded across repeated generations of the index advice according to embodiments of the present invention. Although only eighteen rows of the subject index advice records are visible in text box (404), a user's operation of vertical scroll bar (408) may show many more records of index advice. Similarly, although only eight columns of index advice attributes are visible in text box (404), a user's operation of horizontal scroll bar (406) may display more columns.

The columns of attributes of index advice visible in text box (404) include a column labeled ‘Table’ containing the name of the table for which an index advice was generated. Columns of index advice attributes visible in text box (404) also include a column labeled ‘Columns’ containing the names of columns of the table to be used in forming the advised index, that is, the key columns for the index. Columns of index advice attributes visible in text box (404) also include a column labeled ‘Type’ containing the type of index advised, ‘BR’ representing a binary radix index and ‘EV’ representing an encoded vector index. The contents of columns Table, Columns, and Type represent values of attributes of an index advice that specify an index.

Columns of index advice attributes visible in text box (404) also include a column labeled “Count” containing a cumulative count of the number of times that an index advice has been generated for an index. Columns of index advice attributes visible in text box (404) also include a column labeled “LgEst” standing for ‘Largest Estimate’ and containing a largest estimate of the time required to execute a query for which an index advice was generated. Columns of index advice attributes visible in text box (404) also include a column labeled “AvEst” standing for ‘Average Estimate’ and containing a running average of estimates of the time required to execute a query for which the index advice was generated. The contents of the Count column, the LgEst column, and the AvEst column represent statistical attributes of an index advice.

Columns of index advice attributes visible in text box (404) also include a column labeled “Stamp” containing a timestamp representing the time when an index advice for an index was last generated. The contents of the Stamp column represent attributes of the index advice that characterize usefulness of an index.

Columns of index advice attributes visible in text box (404) also include a column labeled “Time” containing an estimate of the time required to create an index. The contents of the Time column represent attributes of the index advice that characterize cost of creating an index.

In view of the explanations provided in this specification, readers now will recognize that the benefits of continual generation of index advice according to embodiments of the present invention include:
Complete index advice data is available at all times, not just when a database monitor or database performance tool is run.
Index advice data can include statistical data not previously available from database monitors or database performance tools.
Index advice records are generated and recorded continually with no need for any user intervention to run a monitor or a trace.
Index advice records may be presented in easy-to-read form such as the GUI display of FIG. 4, with no need for a user to run a monitor or trace and puzzle over complex printed output to try to tease out a single index advice—which will have no statistic accumulations anyway.
Before creating an index, a user or database administrator has a much improved understanding of how long it would take to create the index, how many queries the index may benefit, and what the operational effects may be on those queries.

Exemplary embodiments of the present invention are described largely in the context of a fully functional computer system for continual generation of index advice. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer implemented method for continual generation of index advice, the method comprising repeatedly carry out the steps of:
generating an index advice for an index of a table in a computer database; and
recording values of statistical attributes of the index advice accumulated across repeated generations of the index advice;
wherein the generating and recording are carried out continually without user intervention.

2. The method of claim 1 wherein statistical attributes of the index advice further comprise:
a cumulative count of the number of times that the index advice has been generated for the index;
a largest estimate of the time required to execute a query for which the index advice was generated; and
a running average of estimates of the time required to execute a query for which the index advice was generated.

3. The method of claim 1 further comprising recording values of attributes of the index advice that specify an index.

4. The method of claim 3 wherein attributes of the index advice that specify an index further comprise:
the name of the table for which the index advice is generated;
one or more names of columns of the table for the index; and
an index type.

5. The method of claim 4 wherein attributes of the index advice that specify an index further comprise:
the location of the table;
one or more names of order-independent columns of the table for the index;
a partition name;
a name of a national language sort sequence table;
the location of the sort sequence table.

6. The method of claim 1 further comprising continually and without user intervention carrying out the steps of:
recording values of attributes of the index advice that characterize usefulness of an index; and
recording values of attributes of the index advice that characterize cost of creating an index.

7. The method of claim 6 wherein attributes of the index advice that characterize usefulness of an index further comprise:
a timestamp representing the time when an index advice for an index was last generated;
a reason why an index advice for an index was last generated; and
the number of rows in the table when an index advice for an index of the table was last generated.

8. The method of claim 6 wherein attributes of the index advice that characterize cost of creating an index further comprise an estimate of the time required to create the index.

9. The method of claim 3 wherein attributes of the index advice that characterize cost of creating the specified index further comprise a page size for the index.

10. An apparatus for continual generation of index advice, the apparatus comprising a computer processor and a computer memory operatively coupled to the computer processor, the computer memory having disposed within it computer program instructions capable of continually and without user intervention carrying out the steps of:
generating an index advice for an index of a table in a computer database; and
recording values of statistical attributes of the index advice accumulated across repeated generations of the index advice.

11. The apparatus of claim 10 wherein statistical attributes of the index advice further comprise:
a cumulative count of the number of times that the index advice has been generated for the index;
a largest estimate of the time required to execute a query for which the index advice was generated; and
a running average of estimates of the time required to execute a query for which the index advice was generated.

12. The apparatus of claim 10 further comprising computer program instructions capable of recording values of attributes of the index advice that specify an index.

13. The apparatus of claim 10 further comprising computer program instructions capable of continually and without user intervention carrying out the steps of:
recording values of attributes of the index advice that characterize usefulness of an index; and
recording values of attributes of the index advice that characterize cost of creating an index.

14. A computer program product for continual generation of index advice, the computer program product disposed upon a signal bearing medium, the computer program product comprising computer program instructions capable of continually and without user intervention carrying out the steps of:
generating an index advice for an index of a table in a computer database; and
recording values of statistical attributes of the index advice accumulated across repeated generations of the index advice.

15. The computer program product of claim 14 wherein the signal bearing medium comprises a recordable medium.

16. The computer program product of claim 14 wherein the signal bearing medium comprises a transmission medium.

17. The computer program product of claim 14 wherein statistical attributes of the index advice further comprise:
a cumulative count of the number of times that the index advice has been generated for the index;
a largest estimate of the time required to execute a query for which the index advice was generated; and
a running average of estimates of the time required to execute a query for which the index advice was generated.

18. The computer program product of claim 14 further comprising computer program instructions capable of recording values of attributes of the index advice that specify an index.

19. The computer program product of claim 14 further comprising computer program instructions capable of continually and without user intervention carrying out the steps of:
recording values of attributes of the index advice that characterize usefulness of an index; and
recording values of attributes of the index advice that characterize cost of creating an index.
